(19) United States
(12) Patent Application Publication
(10) Pub. No.: US 2026/0313424 A1
(43) Pub. Date: Oct. 8, 2026

(54) CHANNEL STATE INFORMATION (CSI) REPORTING BASED ON MULTIPLE CSI SUB-CONFIGURATIONS

(71) Applicant: Apple Inc., Cupertino, CA (US)

(72) Inventors: Dan Wu, Beijing (CN); Hong He, San Jose, CA (US); Dawei Zhang, Saratoga, CA (US); Wei Zeng, Saratoga, CA (US); Sigen Ye, San Diego, CA (US); Weidong Yang, San Diego, CA (US); Haitong Sun, Cupertino, CA (US); Chunhai Yao, Beijing (CN)

(73) Assignee: Apple Inc., Cupertino, CA (US)

(21) Appl. No.: 19/483,174

(22) PCT Filed: May 11, 2023
(86) PCT No.: PCT/CN2023/093566

§ 371 Date: Nov. 10, 2025

(51) Int. Cl. H04W 24/10; H04L 5/00

(52) U.S. Cl. CPC H04W 24/10; H04L 5/005

(57) ABSTRACT

The present application relates to devices and components including apparatus, systems, and methods for CSI reporting based on multiple CSI sub-configurations. In an example, a user equipment (UE) receives a CSI report configuration for CSI reporting. The configuration can indicate “L” sub-configurations based on spatial element adaptations of a base station. For a reporting instance, the UE can determine “N” sub-configurations of the “L”sub-configurations to use. CSI-RS resources are monitored according to the “N” sub-configurations to generate a CSI report. The UE sends the CSI report in the reporting instance.

Cellular communications can be defined in various standards to enable communications between a user equipment and a cellular network. For example, Fifth generation mobile network (5G) is a wireless standard that aims to improve upon data transmission speed, reliability, availability, and more.

### BRIEF DESCRIPTION OF THE DRAWINGS

FIG. 1 illustrates an example of a network environment, in accordance with some embodiments.

FIG. 2 illustrates an example of a spatial element adaptation, in accordance with some embodiments.

FIG. 3 illustrates an example of another example of a spatial element adaptation, in accordance with some embodiments.

FIG. 4 illustrates an example of a sequence diagram between a user equipment (UE) and a network associated within channel state information (CSI) reporting, in accordance with some embodiments.

FIG. 5 illustrates an example of CSI reporting based on “N” sub-configurations of a CSI report configuration, in accordance with some embodiments.

FIG. 6 illustrates an example of a selection of “N” sub-configurations from a CSI report configuration, in accordance with some embodiments.

FIG. 7 illustrates another example of a selection of “N” sub-configurations from a CSI report configuration, in accordance with some embodiments.

FIG. 8 illustrates another example of a selection of “N” sub-configurations from a CSI report configuration, in accordance with some embodiments.

FIG. 9 illustrates another example of a selection of “N” sub-configurations from a CSI report configuration, in accordance with some embodiments.

FIG. 10 illustrates another example of a selection of “N” sub-configurations from a CSI report configuration, in accordance with some embodiments.

FIG. 11 illustrates another example of CSI reporting based on “L” sub-configurations of a CSI report configuration, in accordance with some embodiments.

FIG. 12 illustrates an example of a selection of multiple “N” sub-configurations from a CSI report configuration, in accordance with some embodiments.

FIG. 13 illustrates another example of a selection of multiple “N” sub-configurations from a CSI report configuration, in accordance with some embodiments.

FIG. 14 illustrates another example of a selection of multiple “N” sub-configurations from a CSI report configuration, in accordance with some embodiments.

FIG. 15 illustrates another example of a selection of multiple “N” sub-configurations from a CSI report configuration, in accordance with some embodiments.

FIG. 16 illustrates an example of CSI reporting in multiple reporting instances or reporting occasions, in accordance with some embodiments.

FIG. 17 illustrates an example of an operational flow/algorithmic structure for CSI reporting, in accordance with some embodiments.

FIG. 18 illustrates an example of receive components, in accordance with some embodiments.

FIG. 19 illustrates an example of a UE, in accordance with some embodiments.

FIG. 20 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) communicates with a base station of a network through a communication channel, where a base station can be referred to as a network node as well, such as an evolved Node B (eNB), a next generation node B (gNB), or other base station. The network can include a Fifth generation (5G) system, a New Radio (NR) system, a long term evolution (LTE) system, a combination thereof, or some other wireless systems. The UE and/or base station can include one or more antenna arrays, where each antenna panel can include multiple antenna elements that can be located in close physical location to each other. Some of the antenna elements can be associated with logical antenna ports. In some examples, antenna elements are considered as pseudo-omni or quasi-sector-omni antenna elements including a phase shifter. A directional beam, such as a transmission (Tx) beam or a receiving (Rx) beam, can be formed by adjusting the phase shifter of the antenna element. Channel state information (CSI) reports can provide the network with information about the channel conditions between the UE and the base station.

To reduce energy consumption, the base station may use spatial element adaptation to change the configuration of antenna elements being used in communication. An antenna element may be referred to as a spatial element as well. The base station may disable spatial elements associated with logical antenna ports. Spatial element adaptation may be referred to as transceiver unit (TxRU) reduction because it may limit the number of TxRUs that the base station uses. The base station may control spatial elements at a port level or at the receiver unit level, which can change the CSI-Reference Signal (RS) being transmitted. For example, when the base station disables all the antenna elements associated with an antenna port, the UE may only measure the CSI-RS from the subset of antenna elements of enabled antenna ports. Different channel state information (CSI) report configurations may be provided to the UE for monitoring CSI-RS resources corresponding to the enabled antenna elements determined by the spatial element adaptation. Based on the CSI report configuration provided by the base station, the UE can perform CSI-RS measurements configured by the CSI report configurations, generate CSI reports based on the CSI-RS measurements, and transmit the CSI reports to the base station.

To reduce energy consumption, the base station may additionally or alternatively use power domain adaptation to change the transmission power of signals/channels being used in communication. The base station may disable power amplifiers (PA), which can change the transmission power of channel state information reference signal (CSI-RS) or physical downlink shared channel (PDSCH). For example, when the base station disables half of the PAs associated with a CSI-RS resource an antenna port, the transmission power of the CSI-RS can be reduced by 3 dB, or when base station intends to disable half of the PAs associated with PDSCH transmission, the power offset assumption between CSI-RS and PDSCH can be increased by 3 dB. Different CSI report configurations may be provided to the UE for monitoring CSI-RS resources corresponding to the power offset values determined by the power domain adaptation. Based on the CSI report configuration provided by the base station, the UE can perform CSI-RS measurements configured by the CSI report configurations, generate CSI reports based on the CSI-RS measurements, and transmit the CSI reports to the base station.

The network (e.g., the base station or another network node) can send a CSI report configuration to the UE for use in the CSI reporting. In turn, the CSI report can indicate “L” sub-configurations, where “L” is a positive integer greater than two. Depending on a number of factors (e.g., UE capability, additional configuration or signaling from the network, and/or logic pre-stored by the UE), the UE can generate a CSI report using “N” sub-configurations of the “L” sub-configurations, where this CSI report is sent to the network in a reporting instance (e.g., a CSI reporting occasion). Embodiments of the present disclosure relate at least in part to various techniques for determining and using the “N” sub-configurations as further described herein below. By doing so, the UE can support spatial element adaptation such that energy consumption can be reduced, while CSI reporting remains achievable.

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network node of a communications network, and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

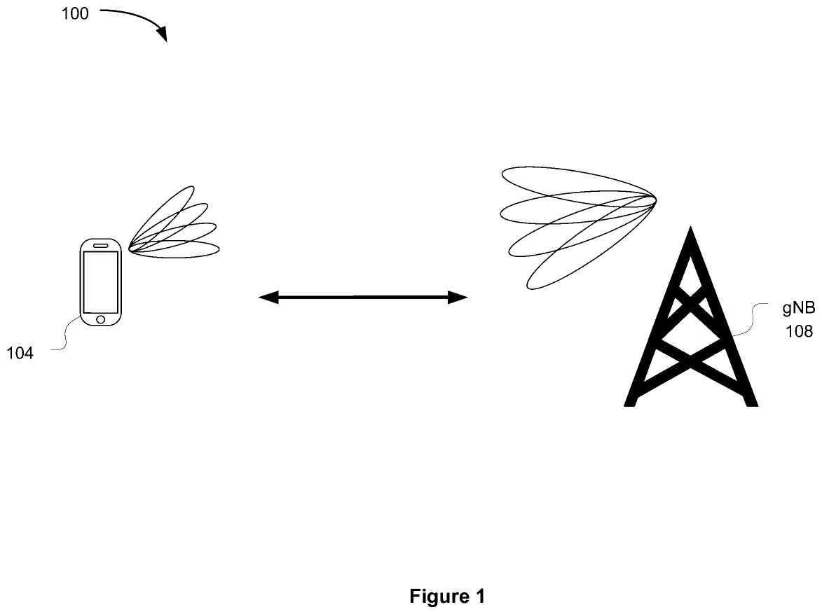

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications such as those that define Fifth Generation (5G) NR system standards.

The gNB 108 may transmit information (for example, data and control signaling) in the downlink direction by mapping logical channels on the transport channels, and transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure (including cell selection and reselection) and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include CSI reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

Transmissions that use different antenna ports may experience different radio channels. However, in some situations, different antenna ports may share common radio channel characteristics. For example, different antenna ports may have similar Doppler shifts, Doppler spreads, average delay, delay spread, or spatial receive parameters (for example, properties associated with a downlink received signal angle of arrival at a UE). Antenna ports that share one or more of these large-scale radio channel characteristics may be said to be quasi co-located (QCL) with one another. 3GPP has specified four types of QCL to indicate which particular channel characteristics are shared. In QCL Type A, antenna ports share Doppler shift, Doppler spread, average delay, and delay spread. In QCL Type B, antenna ports share Doppler shift and Doppler spread. In QCL Type C, antenna ports share Doppler shift and average delay. In QCL Type D, antenna ports share spatial receiver parameters.

The gNB 108 may provide transmission configuration indicator (TCI) state information to the UE 104 to indicate QCL relationships between antenna ports used for reference signals (for example, synchronization signal/PBCH or CSI-RS) and downlink data or control signaling, for example, PDSCH or PDCCH. The gNB 108 may use a combination of RRC signaling, MAC control element signaling, and DCI to inform the UE 104 of these QCL relationships.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1) band (between 40 Megahertz (MHz) and 7,125 MHz) and/or frequency range 2 (FR2) band (between 24,250 MHz and 52,600 MHz). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

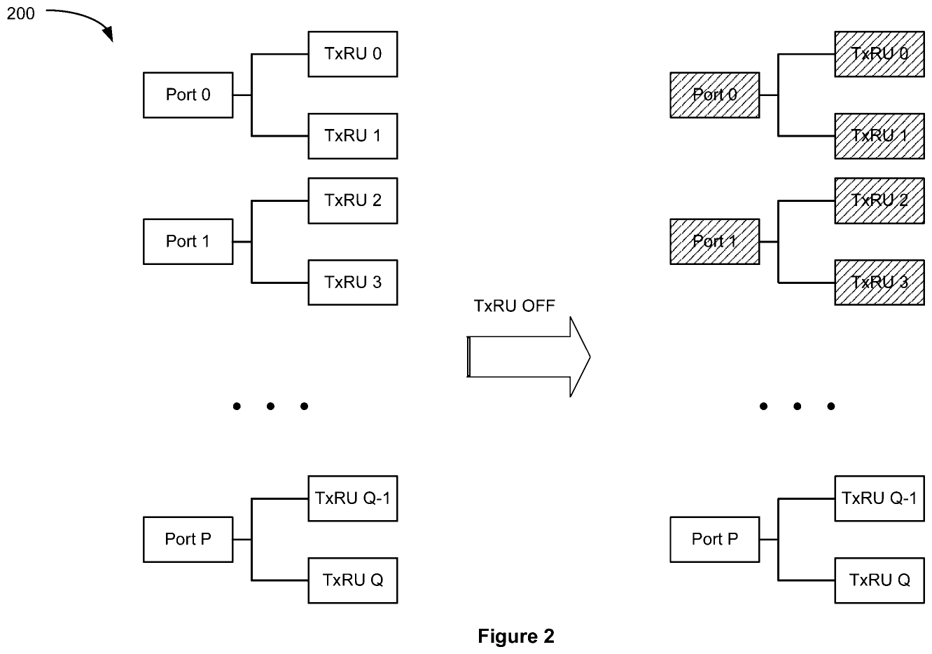

FIG. 2 illustrates an example of a spatial element adaptation 200, in accordance with some embodiments. The spatial element adaptation 200 relates to disabling antenna elements associated with logical antenna ports, such that a logical port and its associated antenna elements can be considered as a disabled set. This spatial element adaptation 200 can be referred to as a type 1 transceiver unit (TxRU) reduction.

As explained herein above, a base station (e.g., the gNB 108) and/or a UE (e.g., the UE 104) includes an antenna system. In general, an antenna system can include one or more antenna panels. An antenna panel can include an array of antenna elements that can be located in close physical location to each other. An antenna element can be an omnidirectional antenna element, a quasi-omnidirectional antenna element, a directional antenna element, or any other antenna element. In some examples, an antenna panel can be a smart antenna system, where all antenna elements are considered as pseudo-omni or quasi-sector-omni antenna elements and include a phase shifter. A directional beam, such as a transmission (Tx) beam or a receiving (Rx) beam, can be formed by adjusting the phase shifter of one or more of the antenna elements.

Type 1 TxRU reduction allows the base station to enable/disable all spatial elements associated with the same logical antenna port (e.g., ports 151). In the illustrated example in FIG. 2, the base station disables Port “0” and Port “1” and enables Port “P.” By disabling Port “0” and Port “1,” the base station disables all the antenna elements associated with Port “0” and Port “1” including TxRU “0,” TxRU “1,” TxRU “2,” TxRU “3.” CSI-RS can only be transmitted from a subset of antenna elements of enabled antenna ports, such as Port “P.” In turn, the UE would then measure the CSI-RS from the subset of enabled antenna ports.

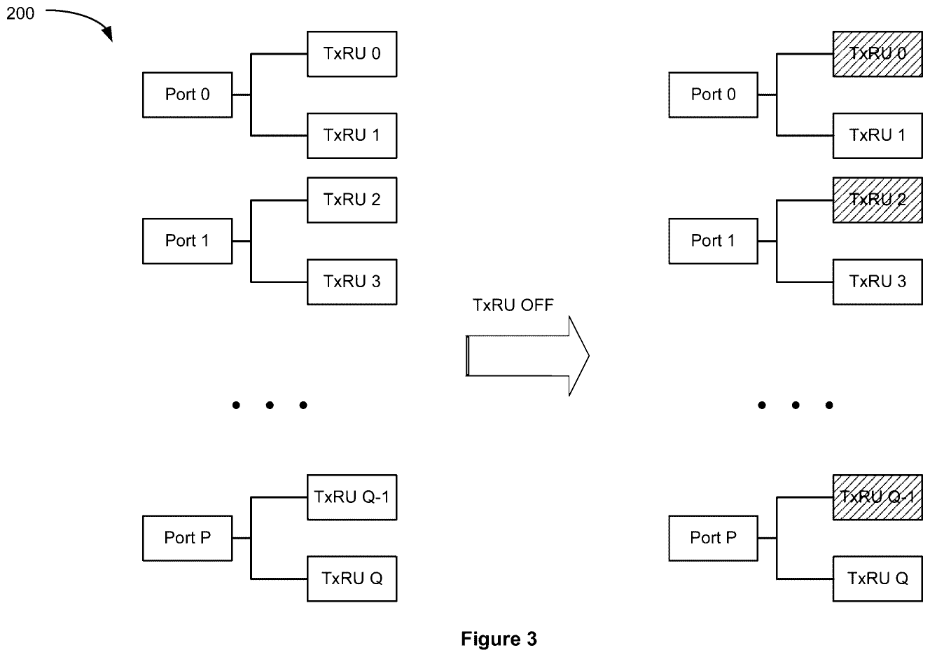

FIG. 3 illustrates an example of another example of a spatial element adaptation 300, in accordance with some embodiments. Here, the spatial element adaptation 300 relates to disabling a subset of antenna elements associated with a logical antenna port. This spatial element adaptation 300 can be referred to as a type 2 transceiver unit TxRU reduction.

Type 2 TxRU reduction allows the base station to enable/disable part of the spatial elements associated with a same logical antenna port. For example, antenna element TxRU “0” associated with Port “0” and antenna element TxRU “2” associated with Port “1” are disabled, while antenna element TxRU “1” associated with Port “0” and antenna element TxRU “3” associated with Port “1” are enabled. The enabled antenna element patterns, such as TxRU “1” and TxRU “3” may result in changes to the antenna pattern, gains, TCI states, and/or transmission power of the reference signal or channel that uses the antenna port(s). The UE may measure the CSI-RS sent from the enabled antenna elements. The measurements may be different than CSI-RS sent from all TxRUs because of the change in the spatial filter. The TxRU reduction for CSI-RS allows for accurate measurements that may be used by the base station for future transmissions using a reduced number of ports or TxRUs.

Referring back to FIGS. 2 and 3, as the different types of TxRU reductions may result in different CSI-RS being transmitted by a base station, it may be desirable to support different CSI report configurations. A CSI report configuration may be associated with a particular spatial element adaptation. Generally, a CSI report configuration indicates various parameters that configures the UE to monitor a particular set of CSI-RS resources to be received on particular antenna ports and generate and send a particular type of a CSI report based on measurements performed on such CSI-RS resources. For example, such parameters can indicate time-domain attributes for the CSI-RS resource set, the CSI report type, the CSI-RS resource set to be monitored. These parameters can include, for instance, a reportConfig parameter, codebookConfig parameter, or a reportConfigType parameter to define a type of CSI-report, and a ResourceConfigparameter to define corresponding CSI-RS resources to be monitored to generate the CSI report. The CSI report can be a periodic, semi-persistent, or aperiodic and can provide CSI feedback from the UE to the base station in response to spatial element adaptation. For example, the CSI report can include one or multiple pieces of information, such as a rank indicator (RI), a precoder matrix indicator (PMI), a channel-quality indicator (CQI), a CSI-RS resource indicator (CRI), or other CSI information such as a layer Indicator (LI), an SS/PBCH resource block indicator (SSBRI). The RI can provide a recommendation on the transmission rank to use preferably for downlink shared channel (DL-SCH) transmission to UE 102. The PMI can indicate a preferred precoder to use for DL-SCH transmission, conditioned on the number of layers indicated by the RI. The precoder recommended by the UE is not explicitly signaled but is provided as an index into a set of predefined matrices, a so called codebook. The CQI can represent the highest modulation-and-coding scheme that, if used, would mean a DL-SCH transmission using the recommended RI and PMI would be received with a block-error probability of at most 10%. The CRI can indicate the beam the UE prefers in case the UE is configured to monitor multiple beams.

In an example, a CSI report configuration can indicate “L” sub-configurations, where “L” is a positive integer greater or equal to two (e.g., the CSI report configuration can indicate at least a first sub-configuration and a second sub-configuration). A sub-configuration can include any or all of the above parameter and can correspond to particular spatial element adaptation. For example, assume that “P” in FIGS. 2 and 3 is equal to thirty-two. “L” can be two. In this case, a first sub-configuration can correspond to all thirty-two ports being enabled, thus corresponding to a thirty-two port codebook or a thirty-two CSI-RS resource with “tci-state #1” or a thirty-two CSI-RS resource with powerControlOffset or powerControlOffsetSS value “P1,” and a second sub-configuration can correspond to sixteen out of the thirty-two ports being enabled (e.g., in the case of the type 1 TxRU reduction), thus corresponding to a sixteen port codebook, or all thirty-two ports being enabled but only one TxRU per antenna port being enabled (e.g., in the case of the type 2 TxRU reduction), thus corresponding to a thirty-two CSI-RS resource with “tci-state #2” or a thirty-two CSI-RS resource with powerControlOffset or powerControlOffsetSS value “P2.” Of course, “L” can be set to a positive integer other than two.

The UE can determine “N” sub-configurations of the “L” sub-configurations such that the UE generates a CSI report based on the “N” sub-configurations and sends the CSI report in a reporting instance (e.g., a CSI reporting occasion). In an example, “N” is a positive integer smaller than “L.” To illustrate and in the interest of simplicity, assume that “P” of FIG. 2 (e.g., in the case of a type 1 TxRU reduction) is thirty-two and “L” is four. In this case, a first sub-configuration can correspond to all thirty-two ports being enabled, a second sub-configuration can correspond to twenty-four out of the thirty-two ports being enabled, a third sub-configuration can correspond to sixteen ports being enabled, and a fourth second sub-configuration can correspond to eight out of the thirty-two ports being enabled. In this illustrative example, “N” can be two. As such, in each CSI reporting instance (e.g., in each CSI report), two of the four sub-configurations are used. Assume that these two sub-configurations are the third and fourth sub-configurations. The CSI report can correspond to a first CSI report generated based on CSI-RS resources received using the third sub-configuration (e.g., the sixteen ports) and a second CSI report generated based on CSI-RS resources received using the fourth sub-configuration (e.g., the eight ports). In other words, a CSI report can include one or more CSI reports, each of which generated based on a sub-configuration of “N” sub-configuration. Accordingly, the CSI reports can include multiple CSIs, each corresponding to one of the “N” sub-configurations. In an example, “N” is the number of CSIs that are reported in a reporting instance (e.g., the number of CSI reports that can collectively represent a single CSI report sent in the reporting instance).

In an example, the CSI report type is semi-persistent. In this case, the UE can also determine a positive integer “N” that may be equal to or smaller than “L” and report in one or more reporting instances CSI using the “L′” sub-configurations.

In an example, the UE determines a positive integer “T” for consecutive reporting instances of the same CSI to be reported. In other words, say that the third and fourth sub-configurations are used as per the example above in the case of “L” equals four and “N” equals two. The CSI report is sent consecutively in “T” reporting instances before next “N” sub-configurations are used for CSI reporting.

The above and other features related to sub-configurations of a CSI report configuration are further described herein below. Such sub-configurations can apply to the different type of CSI reporting (e.g., periodic, semi-persistent, or aperiodic) unless indicated otherwise herein.

Further herein, various embodiments are described in connection to spatial element adaptation. Nonetheless, the embodiments are not limited as such. For instance, embodied techniques can be similarly applied to power adaptation. Generally, different spatial element adaptations would use different sets of reporting parameters (e.g., antenna ports, antenna elements, codebook, or other parameters that may be set for CSI reporting). Similarly, different power adaptation would also use different sets of reporting parameters (where these parameters may be the same or different from the ones uses for spatial element adaptations). As such, the embodied techniques enable using a particular CSI sub-configuration that may be associated with a particular set of reporting parameters.

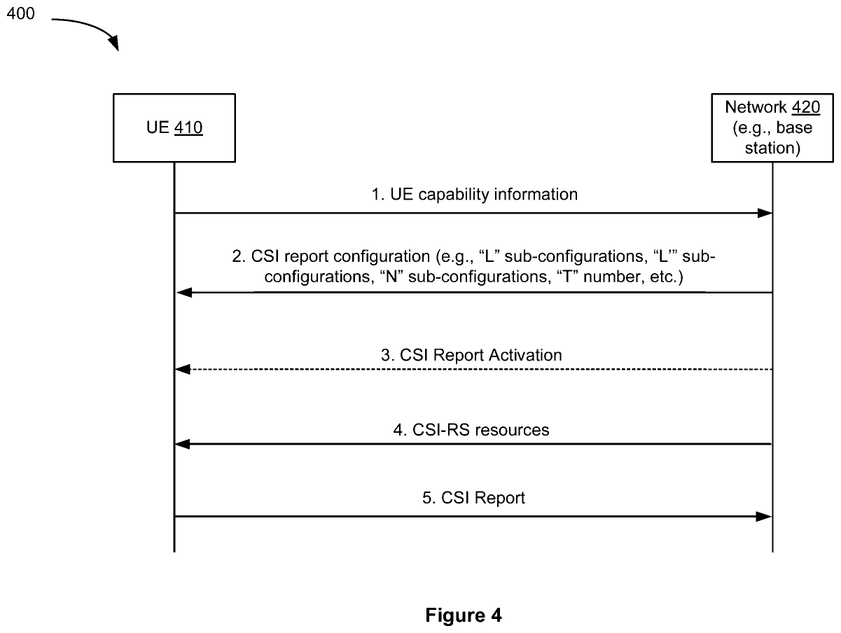

FIG. 4 illustrates an example of a sequence diagram 400 between UE 410 (e.g., the UE 104) and a network 420 associated within CSI reporting, in accordance with some embodiments. As illustrated, the sequence diagram 400 can involve the UE 410 reporting UE capability information to the network 420 (e.g., to a base station thereof, such as the gNB 108). The UE capability information can be sent in RRC signaling (e.g., as an information element), optionally in response to a UE capability inquiry of the network 420. The UE capability information can indicate the capability of the UE to support CSI reporting in association with spatial element adaptation by including, for instance, the supported number(s) of sub-configurations (e.g., a maximum “L” annotated as “Lₘₐₓ”, a maximum “L′” annotated as “L′ₘₐₓ”), and/or the supported number of CSI(s) in one reporting instance/occasion (e.g. a maximum “N” annotated as “Nₘₐₓ”) and/or the supported number of repetitions “T” annotated as “Tₘₐₓ”.

Thereafter, the network 420 (e.g., the base station) can send and the UE 410 can receive a CSI report configuration. This configuration can be based on the UE capability information (such as being based on the supported number(s) of sub-configurations and/or the supported number of repetitions “T”). Depending on the type of configured CSI reporting (e.g., in the case of aperiodic CSI reporting or in the case of the first semi-persistent CSI reporting), the network 420 (e.g., the base station) can activate CSI reporting. The activation can rely on a signaling trigger send from the base station, such as RRC signaling, medium access control (MAC) control element (CE), and/or DCI). The network 420 (e.g., the base station) also sends CSI-resources to the UE 410. In particular, the CSI-RS resources are sent using a set of enabled antenna ports and/or TxRU elements depending on spatial element adaptation by the base station. The UE 410 uses “N” sub-configurations of “L” configurations indicated in the CSI configuration report to monitor the CSI-RS resource sets, perform CSI-RS related measurements, and generate CSI for reporting in one or more reporting instances.

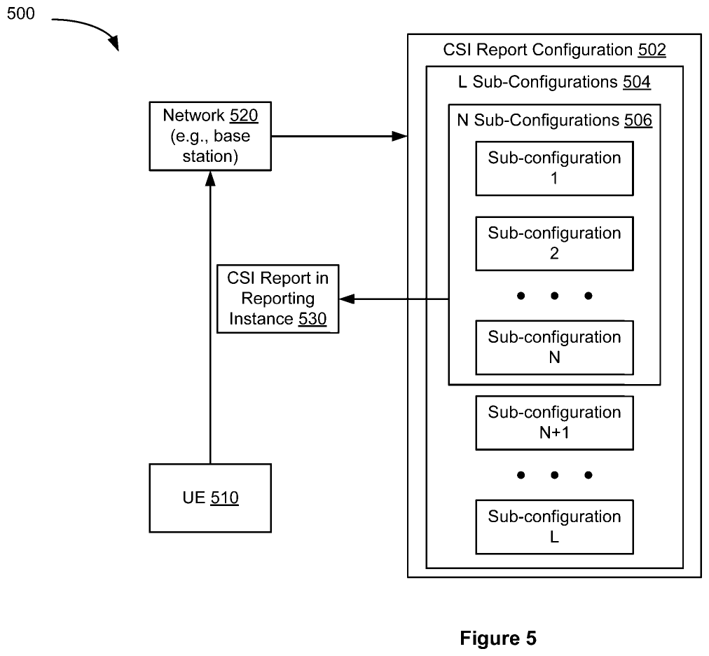

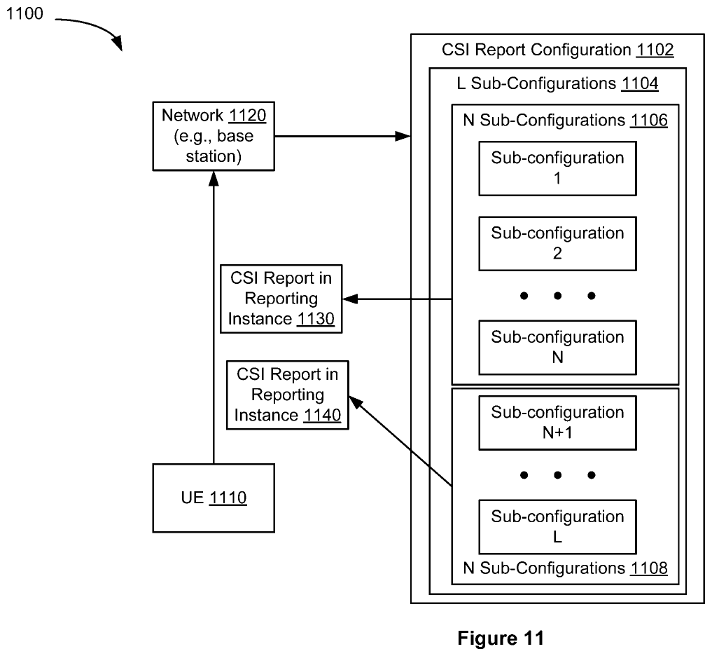

For periodic CSI reporting with “N<L,” the total number of CSIs to be reported can be “N” (e.g., in a single CSI reporting instance) or “L” (e.g., in multiple reporting instances, where the total number of CSIs to be reported per reporting instance is “N”). Whether the total number should be “N” or “L” can be predefined in a technical specification with which the UE is compatible or complies (e.g., by storing logic that can be executed by the UE to determine whether the total number should be “N” or “L”) and/or configured by the network (e.g., via RRC signaling or other type of signaling). Either way, only “N” CSIs are to be reported in one reporting instance. A similar approach can be implemented for aperiodic or semi-persistent CSI reporting. Specific to the semi-persistent reporting, rather than using “L,” an number “L” that can be smaller or equal to “L” can be used. The CSI reporting of only “N” CSIs is described in connection with FIGS. 5-10. The CSI reporting of “L” or “L′” CSIs is described in connection with FIGS. 11-15. Here, “N,” “L” and “L” refer to the numbers “N,” “L′” and “L” of sub-configurations.

FIG. 5 illustrates an example of CSI reporting based on “N” sub-configurations of a CSI report configuration, in accordance with some embodiments. As illustrated, a network 520 (e.g., a base station) sends a CSI report configuration 502 to a UE 510. The CSI report configuration 502 includes “L” sub-configurations 504. In turn, the UE 510 reports “N” CSIs in a reporting instance 530, where the “N” CSIs correspond to “N” sub-configurations of the “L” sub-configurations. The CSI reporting can be periodic, aperiodic, or semi-persistent.

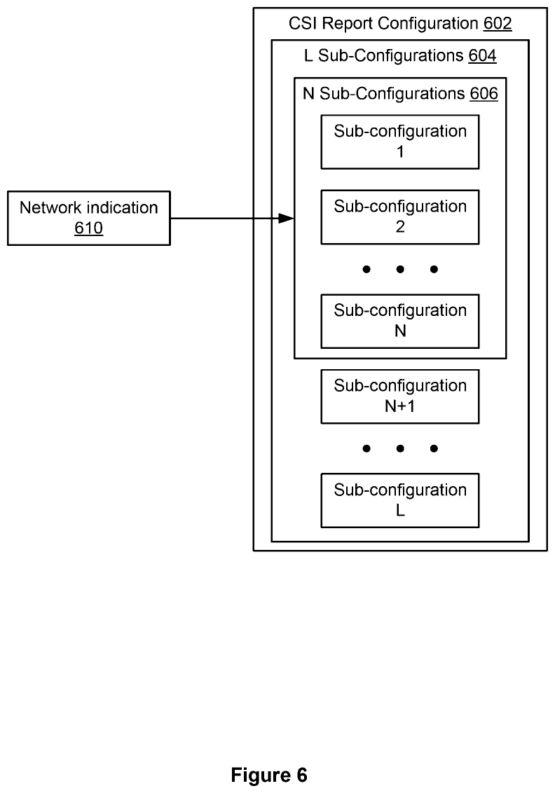

In an example, the network 520 (e.g., the base station) can configure the UE (e.g., via RRC signaling, MAC CE, and/or DCI) to determine which “N” sub-configurations to select for use from the “L” sub-configurations. As such, the selection of the N″ sub-configurations can be network-indicated as further described in FIG. 6.

In another example, no signaling from the network 520 is used for the UE to determine which “N” sub-configurations to select for use from the “L” sub-configurations.

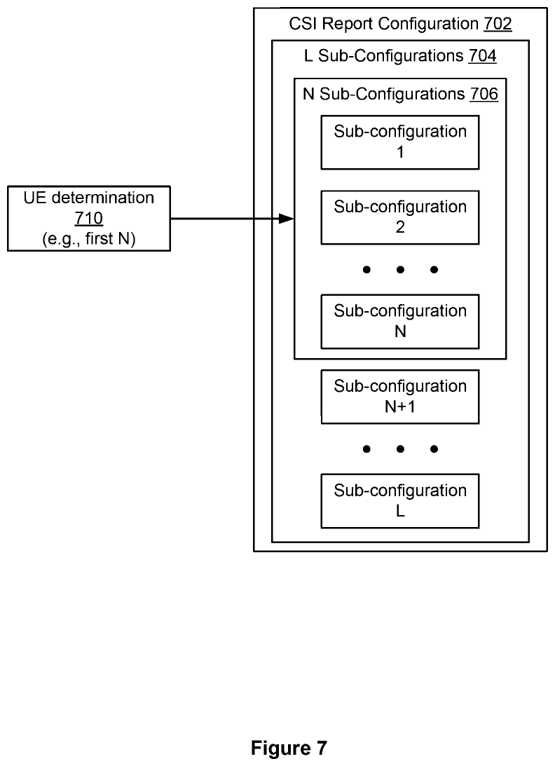

Instead, the selection can be based on prestored logic that the UE 510 executes. This logic can be UE-implementation specific or can implement a definition in a technical specification with which the UE 510 is compatible or complies. As such, the selection of the N″ sub-configurations can be UE-determined as further described in FIGS. 7-10.

FIG. 6 illustrates an example of a selection of “N” sub-configurations from a CSI report configuration, in accordance with some embodiments. As illustrated, a CSI report configuration 602 is defined for a UE and include “L” sub-configuration 604. The UE receives a network indication 610 (e.g., via RRC signaling, MAC CE, and/or DCI from a base station) indicating “N” sub-configurations 606 of the “L” sub-configurations 604 to use for CSI reporting in a single reporting instance.

In an example, each one of the “L” sub-configurations 604 is associated with a sub-configuration identifier (ID). The network indication 610 can indicate the values of the sub-configuration IDs to use. In the illustration of FIG. 6, these values are “1”, “2,” . . . “N.”

FIG. 7 illustrates another example of a selection of “N” sub-configurations from a CSI report configuration, in accordance with some embodiments. As illustrated, a CSI report configuration 702 is defined for a UE and include “L” sub-configuration 704. Unlike FIG. 6, the UE need not receive a network indication of which “N” of the “L” sub-configurations the UE should use. Instead, a UE determination 710 (based on the execution of its prestored logic) can identify, to the UE, “N” sub-configurations 706 of the “L” sub-configurations 704 to use for CSI reporting in a single reporting instance.

In an example, the logic indicates that CSI using the first “N” sub-configurations is to be reported. In the illustration of FIG. 7, each one of the “L” sub-configurations 704 is associated with a sub-configuration identifier (ID). In this illustration, the first “N” sub-configurations correspond to the values of “1”, “2,” . . . “N.” Although the figure shows the “L” sub-configurations being ordered in an ascending order according to their IDs, that need not be the case (e.g., a different order is possible, and “first,” “second,” and so on refers to the first “N” sub-configurations in the order, the next “N” sub-configurations in the order, and so on. In other words, the order may not depend on the IDs).

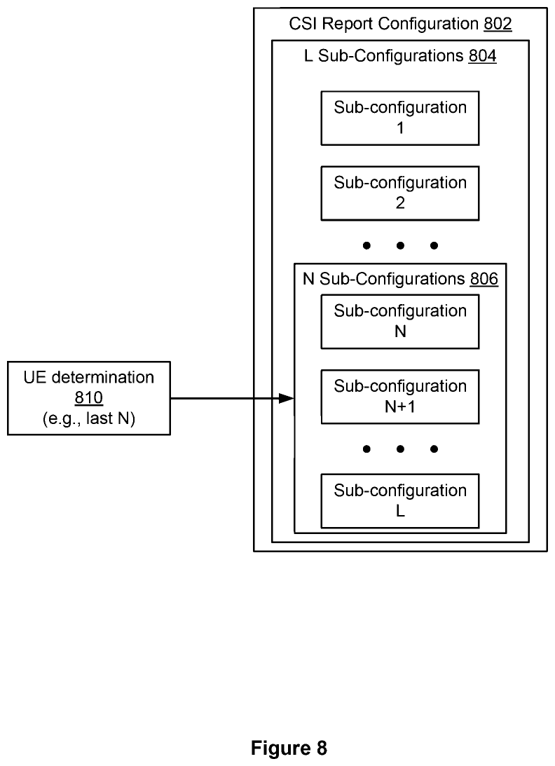

FIG. 8 illustrates another example of a selection of “N” sub-configurations from a CSI report configuration, in accordance with some embodiments. Rather than using the first “N” sub-configurations as in FIG. 7, sub-configuration IDs can be used in FIG. 8 (e.g., the smallest IDs, or the largest IDs).

As illustrated, a CSI report configuration 802 is defined for a UE and include “L” sub-configuration 804. Here also, the UE need not receive a network indication of which “N” of the “L” sub-configurations the UE should use. Instead, a UE determination 810 (based on the execution of its prestored logic) can identify, to the UE, “N” sub-configurations 806 of the “L” sub-configurations 804 to use for CSI reporting in a single reporting instance.

In an example, the logic indicates that CSI using the lowest “N” sub-configuration IDs is to be reported. In the illustration of FIG. 8, each one of the “L” sub-configurations 804 is associated with a sub-configuration identifier (ID). In this illustration, the lowest “N” sub-configurations correspond to the values of “N+1”, . . . , “L.”

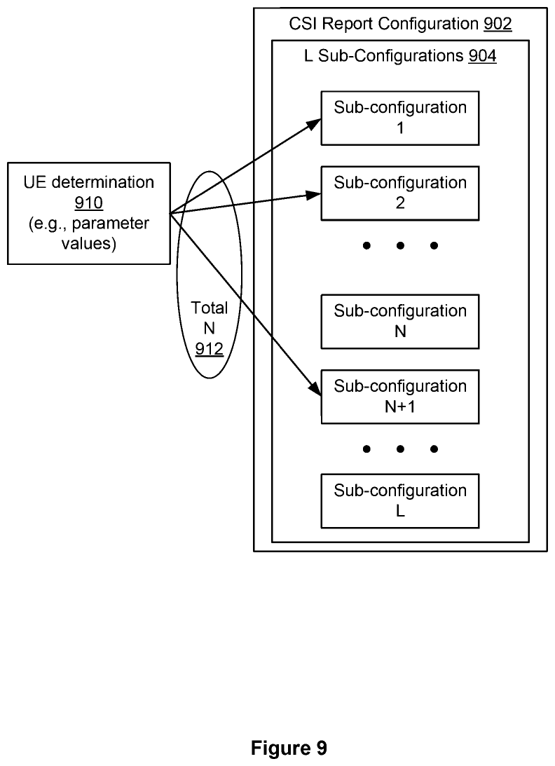

FIG. 9 illustrates another example of a selection of “N” sub-configurations from a CSI report configuration, in accordance with some embodiments. Rather than using the first or last “N” sub-configurations as in FIG. 7 or 8, a set of parameters associated with CSI-RS resource or CSI reporting is used. In an example, the set of parameters includes at least one of a number of ports or a codebook size. Such parameters can be included in a CSI-RS resource configuration or report sub-configuration.

As illustrated, a CSI report configuration 902 is defined for a UE and include “L” sub-configuration 904. Here also, the UE need not receive a network indication of which “N” of the “L” sub-configurations the UE should use. Instead, a UE determination 910 (based on the execution of its prestored logic) can identify, to the UE, a total “N” 912 of sub-configurations from the “L” sub-configurations 904 to use for CSI reporting in a single reporting instance.

In an example, the logic can indicate that CSI using the “N” sub-configurations corresponding to CSI-RS configurations having the “N” largest parameter values (e.g., the largest number of ports and/or the largest codebook size) is to be reported. This approach can be suitable for the case where the base station is in an active mode. Conversely, the logic can indicate that CSI using the “N” sub-configurations corresponding to CSI-RS configurations having the “N” smallest parameter values (e.g., the smallest number of ports and/or the smallest codebook size) is to be reported. This approach can be suitable for the case where the base station is normally in a sleep mode. In the illustration of FIG. 9, each one of the “L” sub-configurations 904 is associated with a sub-configuration identifier (ID). In this illustration, the “N” sub-configurations correspond to the values of “1”, “2”, and “N+1” for the total “N” 912 of three (e.g., “N” is equal to three in this particular illustration and corresponds to “1,” “2,” and “N+1”).

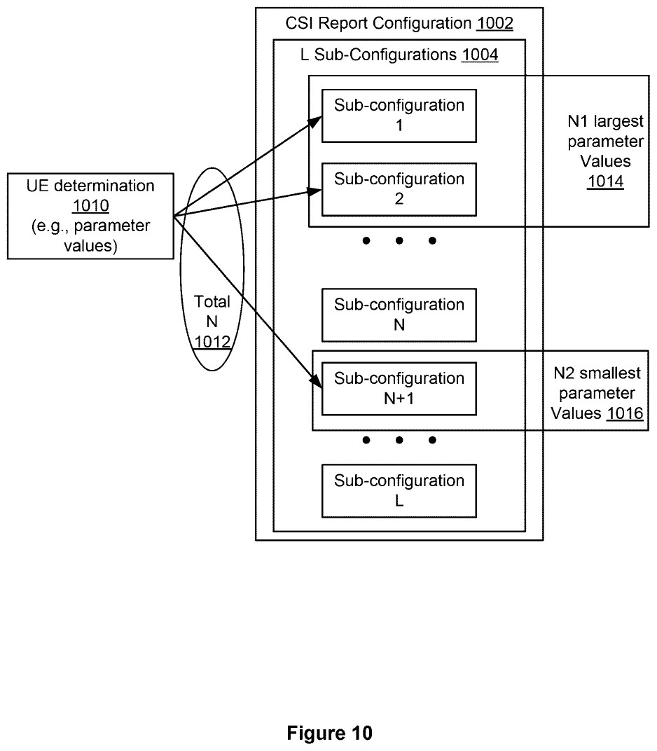

FIG. 10 illustrates another example of a selection of “N” sub-configurations from a CSI report configuration, in accordance with some embodiments. The approach of FIG. 10 is similar to that of FIG. 9, except it can be more granular and more adaptive by mixing between the largest and smallest parameter values. In particular “N1” largest parameter values 1014 and “N2” largest parameter values 1016 are used, where “N” is equal to the sum of “N1” and “N2”. This approach can be suitable for the case where the base station would like to obtain a CSI quickly enough to obtain more diverse CSIs.

As illustrated, a CSI report configuration 1002 is defined for a UE and include “L” sub-configuration 1004. Here also, the UE need not receive a network indication of which “N” of the “L” sub-configurations the UE should use. Instead, a UE determination 1010 (based on the execution of its prestored logic) can identify, to the UE, a total “N” 1012 of sub-configurations from the “L” sub-configurations 1004 to use for CSI reporting in a single reporting instance.

In an example, the logic can indicate that CSI using the “N” sub-configurations corresponding to CSI-RS configurations having the “N1” largest parameter values 1014 (e.g., the largest number of ports and/or the largest codebook size) and to CSI-RS configurations having the “N2” smallest parameter values 1016 (e.g., the largest number of ports and/or the largest codebook size) is to be reported. In the illustration of FIG. 10, each one of the “L” sub-configurations 1004 is associated with a sub-configuration identifier (ID). In this illustration, the “N1” sub-configurations correspond to the values of “1”, “2”, and the “N2” sub-configuration correspond to the value of “N+1” for the total “N” 1012 of three (e.g., “N” is equal to three in this particular illustration and corresponds to “1,” “2,” and “N+1”).

For illustrative purposes, assume four sub-configurations in a type 1 TxRU reduction (e.g., “L” is equal to four) and correspond to thirty-two, twenty-four, sixteen, and eight ports. Assume that “N” is equal to two. And assume that the largest and smallest port numbers are used, whereby “N1” is equal to one and “N2” is likewise equal to one. In this illustration, two CSIs are reported in a reporting instance and correspond to the thirty-two port sub-configuration (e.g., the largest antenna port number) and the eight port sub-configuration (e.g., the smallest antenna port number).

FIG. 11 illustrates another example of CSI reporting based on “L” sub-configurations of a CSI report configuration, in accordance with some embodiments. Here, unlike the approach in FIG. 5, CSI reporting is performed for the “L” sub-configurations (or, in the case of semi-persistent CSI reporting, for “L′” sub-configurations). Each reporting instance is used for CSI reporting using “N” sub-configurations. As such, multiple reporting instances are used for the entirety of the CSI reporting.

As illustrated, a network 1120 (e.g., a base station) sends a CSI report configuration 1102 to a UE 1110. The CSI report configuration 1102 includes “L” sub-configurations 1104. In turn, the UE 1110 reports “N” CSIs in each reporting instance, such that “L” CSIs are reported in multiple reporting instances. FIG. 11 shows the use of two reporting instances (e.g., “L” is the double of “N”), although more than two reporting instances are possible. In a first reporting instance 1130, first “N” sub-configurations 1106 of the “L”: sub-configurations 1104 are used for first CSI reporting (corresponding to the values of “1”, “2” through “N”). In a second reporting instance 1140, next “N” sub-configurations 1108 of the “L” sub-configurations 1104 are used for first CSI reporting (corresponding to the values of “N+1” through “L”). The CSI reporting can be periodic, aperiodic, or semi-persistent.

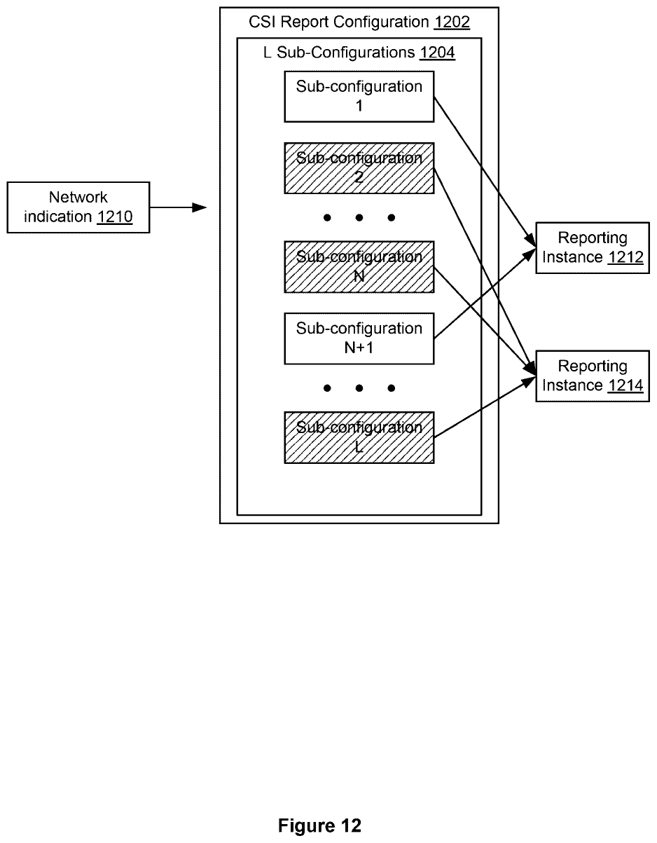

In an example, the network 1120 (e.g., the base station) can configure the UE (e.g., via RRC signaling, MAC CE, and/or DCI) to determine which “N” sub-configurations to select from the “L” sub-configurations for use in each reporting instance. As such, the selection of the N′ sub-configurations can be network-indicated as further described in FIG. 12.

In another example, no signaling from the network 1120 is used for the UE to determine which “N” sub-configurations to select from the “L” sub-configurations for use in each reporting instance. Instead, the selection can be based on prestored logic that the UE 1110 executes. This logic can be UE-implementation specific or can implement a definition in a technical specification with which the UE 1110 is compatible or complies. As such, the selection of the N′ sub-configurations can be UE-determined as further described in FIGS. 12-15.

FIG. 12 illustrates an example of a selection of multiple “N” sub-configurations from a CSI report configuration, in accordance with some embodiments. As illustrated, a CSI report configuration 1202 is defined for a UE and include “L” sub-configuration 1204. The UE receives a network indication 1210 (e.g., via RRC signaling, MAC CE, and/or DCI from a base station) indicating first “N” sub-configurations of the “L” sub-configurations 1204 to use for CSI reporting in a first reporting instance 1212, second “N” sub-configurations of the “L” sub-configurations 1204 to use for CSI reporting in a second reporting instance 1214, and so on.

In an example, each one of the “L” sub-configurations 1204 is associated with a sub-configuration identifier (ID). The network indication 1210 can indicate the values of the sub-configuration IDs to use. In the illustration of FIG. 12, these values include “1”, and “N+1” for the first reporting instance and “2,” “N,” and “L” for the second reporting instance 1214.

In a particular illustration, the network configures a pattern (e.g., the network indication 1210 includes the pattern), by ordering the “L” sub-configurations 1204 (e.g., based on their corresponding IDs). The UE can report “N” CSI(s) in each reporting instance according to the pattern. For instance, “L” is equal to four and “N” is equal to two. The network configures a pattern of sub-configuration IDs of {2,3,1,4}. The UE reports the second and third sub-configurations in the first reporting instance and then the first and fourth sub-configurations in the second reporting instance. The pattern can be signaled via RRC signaling, MAC CE, and/or DCI.

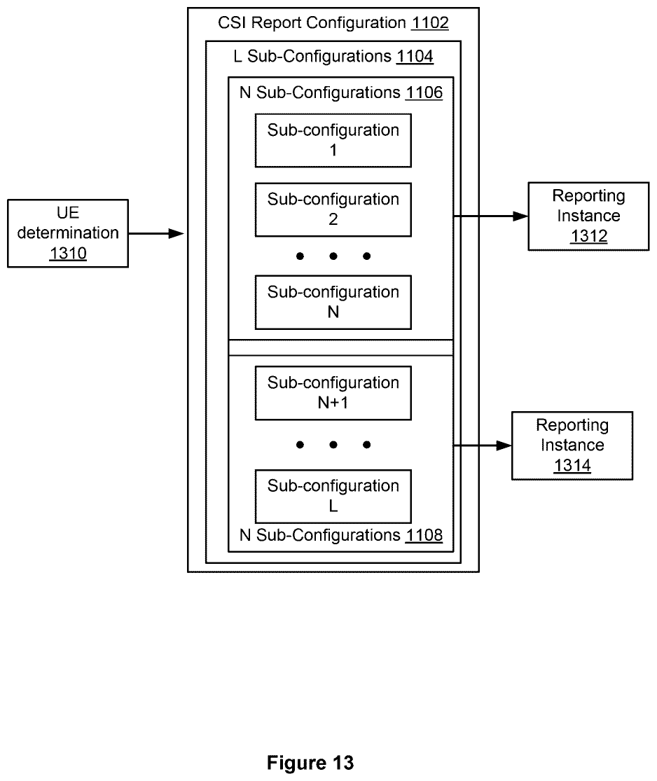

FIG. 13 illustrates another example of a selection of multiple “N” sub-configurations from a CSI report configuration, in accordance with some embodiments. As illustrated, a CSI report configuration 1302 is defined for a UE and include “L” sub-configuration 1304. Unlike FIG. 12, the UE need not receive a network indication of which “N” of the “L” sub-configurations the UE should use in each reporting instance. Instead, a UE determination 1310 (based on the execution of its prestored logic) can identify, to the UE, “N” sub-configurations of the “L” sub-configurations 1304 to use for CSI reporting in each reporting instance.

In an example, the logic indicates that CSI using the first “N” sub-configurations 1106 are to be reported in the first reporting instance 1312, CSI using the next “N” sub-configurations 1108 are to be reported in the next reporting instance 1314, and so on. In the illustration of FIG. 13, each one of the “L” sub-configurations 1304 is associated with a sub-configuration identifier (ID). Alternatively, the opposite order can be used. Although the figure shows the “L” sub-configurations being ordered in a descending order according to their IDs, that need not be the case (e.g., a different order is possible, and “first,” “second,” and so on refers to the first “N” sub-configurations in the order, the next “N” sub-configurations in the order, and so on. In other words, the order may not depend on the IDs). In this illustration, the first “N” sub-configurations 1106 correspond to the values of “1”, “2,” . . . “N” and the second “N” sub-configurations 1108 correspond to the values of “N+1,” . . . “L.”

In another example, rather than using the first “N” sub-configurations as in FIG. 13, sub-configuration IDs can be used in FIG. 13. In this example, the logic indicates that CSI using the lowest “N” sub-configuration IDs (or largest IDs) is to be reported in the first reporting instance 1312, CSI using the next the lowest “N” sub-configuration IDs (or next largest IDs) is to be reported in the second reporting instance 1314, and so on. In this illustration, the lowest “N” sub-configurations correspond to the values of “N+1”, . . . , “L,” the next lowest “N” sub-configurations correspond to the values of “1”, “2,” . . . “N.”

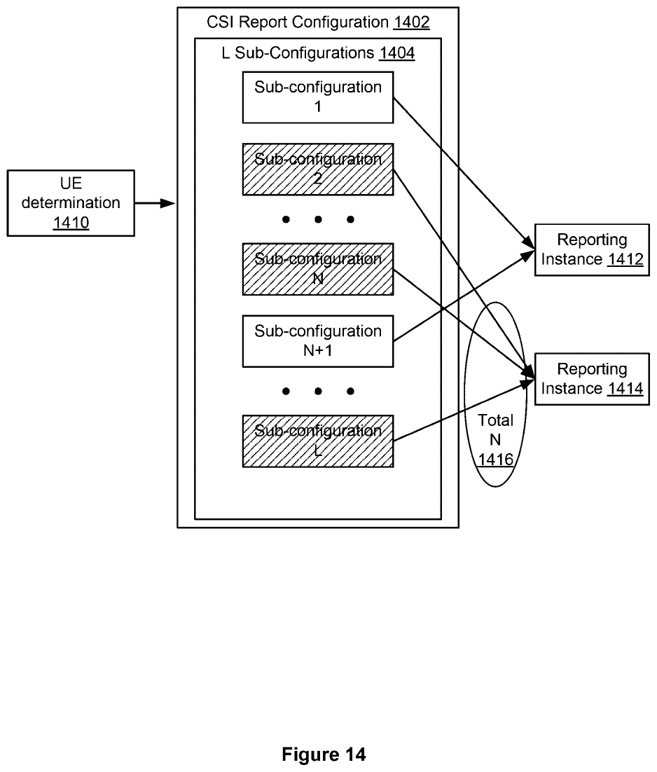

FIG. 14 illustrates another example of a selection of multiple “N” sub-configurations from a CSI report configuration, in accordance with some embodiments. Rather than using the order of sub-configurations or the order of sub-configuration IDs as in FIG. 13, a set of parameters associated with CSI is used. In an example, the set of parameters includes at least one of a number of ports or a codebook size. Such parameters can be included in a CSI-RS configuration.

As illustrated, a CSI report configuration 1402 is defined for a UE and include “L” sub-configuration 1404. Here also, the UE need not receive a network indication of which “N” of the “L” sub-configurations the UE should use in each reporting instance. Instead, a UE determination 1410 (based on the execution of its prestored logic) can identify, to the UE, a total “N” 1412 of sub-configurations from the “L” sub-configurations 1404 to use for CSI reporting in each reporting instance.

In an example, the logic can indicate that CSI using the “N” sub-configurations corresponding to CSI-RS configurations having the “N” largest parameter values (e.g., the largest number of ports and/or the largest codebook size) is to be reported in a first reporting instance 1412, CSI using the “N” sub-configurations corresponding to CSI-RS configurations having the next “N” largest parameter values (e.g., the next largest number of ports and/or the next largest codebook size) is to be reported in a next reporting instance 1414, and so on. Conversely, the logic can indicate that CSI using the “N” sub-configurations corresponding to CSI-RS configurations having the “N” smallest parameter values (e.g., the smallest number of ports and/or the smallest codebook size) is to be reported in the first reporting instance 1412, CSI using the “N” sub-configurations corresponding to CSI-RS configurations having the next “N” smallest parameter values (e.g., the next smallest number of ports and/or the next smallest codebook size) is to be reported in the next reporting instance 1414, and so on. In the illustration of FIG. 14, each one of the “L” sub-configurations 1404 is associated with a sub-configuration ID. In this illustration, the “N” sub-configurations used for the first reporting instance 1412 correspond to the values of at least “1”, and “N+1”, whereas the “N” sub-configurations used for the next reporting instance 1414 correspond to the values of at least “2”, “N,” and “L”.

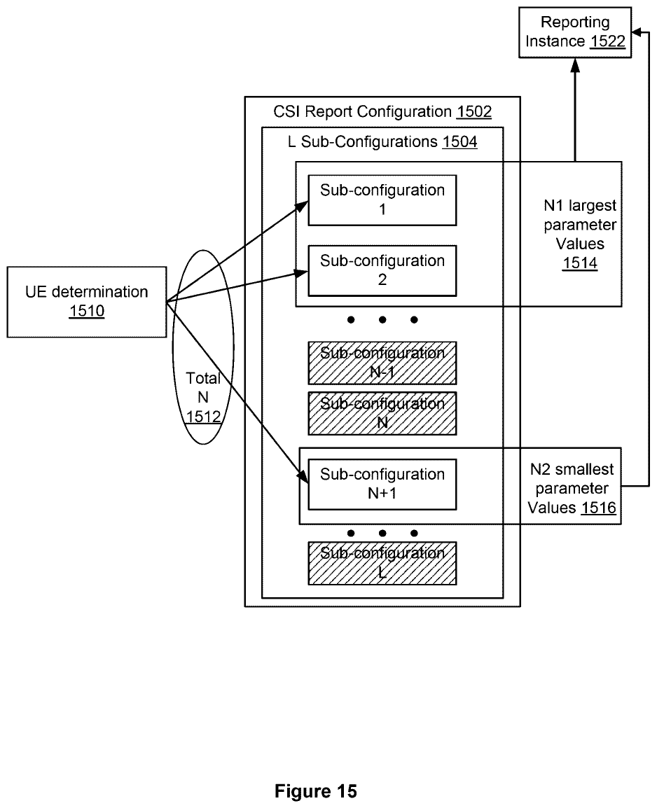

FIG. 15 illustrates another example of a selection of multiple “N” sub-configurations from a CSI report configuration, in accordance with some embodiments. The approach of FIG. 15 is similar to that of FIG. 14, except it can be more granular and more adaptive by mixing between the largest and smallest parameter values. In particular “N1” largest parameter values 1514 and “N2” largest parameter values 1516 are used for each reporting instance, where “N” is equal to the sum of “N1” and “N2”.

As illustrated, a CSI report configuration 1502 is defined for a UE and include “L” sub-configuration 1504. Here also, the UE need not receive a network indication of which “N” of the “L” sub-configurations the UE should use. Instead, a UE determination 1510 (based on the execution of its prestored logic) can identify, to the UE, a total “N” 1512 of sub-configurations from the “L” sub-configurations 1504 to use for CSI reporting in each reporting instance.

In an example, the logic can indicate that CSI using “N” sub-configurations corresponding to CSI-RS configurations having the “N1” largest parameter values 1514 (e.g., the largest number of ports and/or the largest codebook size) and to CSI-RS configurations having the “N2” smallest parameter values 1516 (e.g., the largest number of ports and/or the largest codebook size) is to be reported in a first reporting instance 1522. For the next reporting instance, the logic can indicate that that CSI using “N” sub-configurations corresponding to CSI-RS configurations having the next “N1” largest parameter values (e.g., and to CSI-RS configurations having the enxt “N2” smallest parameter values 1516 is to be reported, and so on. In the illustration of FIG. 15, each one of the “L” sub-configurations 1504 is associated with a sub-configuration ID. In this illustration, for the first reporting instance 1522, the “N1” sub-configurations correspond to the values of “1”, “2”, and the “N2” sub-configuration correspond to the value of “N+1”. As shown with the diagonally dashed rectangles, for the next reporting instance, the “N1” sub-configurations correspond to the values of “N-1”, “N”, and the “N2” sub-configuration correspond to the value of “L”.

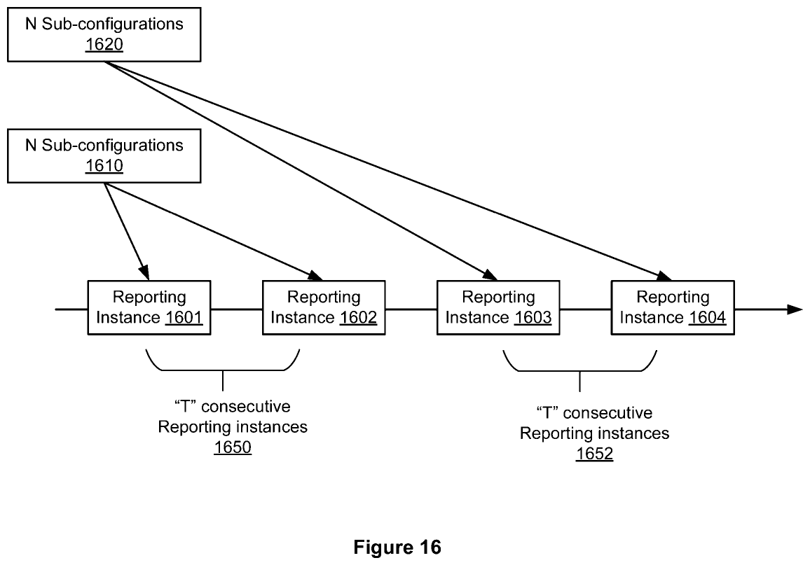

FIG. 16 illustrates an example of CSI reporting in multiple reporting instances or reporting occasions, in accordance with some embodiments. This example reporting can apply when multiple reporting instances are used, where each corresponds to using “N” sub-configurations such a total of “L” sub-configurations (or “L′” sub-configurations) are used, as described in FIGS. 11-15. Here, a positive integer “T” can be used to indicate the number of consecutive reporting instances in which first CSI generated using a first set of “N” sub-configurations should be reported, before reporting second CSI generated using the next set of “N” sub-configurations. The value of “T” can be the same for all the CSI reporting. Alternatively, the value of “T” can change (e.g., “T1” is used for the reporting of the first CSI, “Tw” is used for the reporting of the next CSI, and so on). The value(s) of “T” can be configured via RRC signaling, MAC CE, or DCI.

As illustrated, first “N” sub-configurations 1610 (e.g., as determined based on any of the approaches of FIGS. 12-15) are used for first CSI reporting. The first CSI reporting is repeatedly sent in a first reporting instance 1601 and a second reporting instance 1602 according to a configured value 1650 defining “T” consecutive reporting instances (here, this value is two). The first reporting instance 1601 and the second reporting instance 1602 are consecutive in a sense, that in the time domain, they correspond to CSI reporting occasions that are consecutive.

As further illustrated, the next “N” sub-configurations 1620 (e.g., as determined based on any of the approaches of FIGS. 12-15) are used for second CSI reporting. The second CSI reporting is repeatedly sent in a third reporting instance 1603 and a fourth reporting instance 1604 according to a configured value 1652 defining “T” consecutive reporting instances (here, this value is also two although it may be different such that two “T1” and “T2” values are used). The third reporting instance 1603 and the fourth reporting instance 1604 are consecutive in a sense, that in the time domain, they correspond to CSI reporting occasions that are consecutive.

In this way, the first “N” CSI(s) will be reported in “T” (or “T1”) consecutive reporting instances 1601-1602, the next “N” CSI(s) will be reported in the next “T” (or “T2”) consecutive reporting instances 1603-1604, and so on. If “N” is equal to one, the value of “T” (or each value of “T1” and “T2”) can be configured per sub-configuration to provide more flexibility. In all cases, the value of “T” (or each value of “T1” and “T2”) can be included in the CSI report configuration (possibly, in each sub-configuration).

Referring back to FIGS. 5-16, the CSI reporting can be semi-persistent. For semi-persistent CSI reporting with “N<L,” a total of “L′≤L” CSIs can be reported, and “N” CSI(s) can be reported in one reporting instance. “L′” can be indicated in the activation signaling (e.g., in MAC CE). If not indicated, “L′” can be by default to be “L” or “N.”

If it is by default or indicated that a total of “L′=N” CSI(s) are to be reported, multiple options exist. In a first option, the network can configure a pattern (e.g., via RRC signaling or in a MAC CE) by ordering the sub-configurations. In this option, the UE can report “N” CSI(s) in each reporting instance according to the pattern, similar to the approach in FIG. 12. In a second option, any of the approaches of FIGS. 6-10 can be considered, and a UE determination or a network indication can be implemented to support this option and indicate which approach to use.

If it is by default or indicated that a total of “L′>N” CSIs are to be reported, also different options exist. In a first option, the pattern approach of FIG. 12 can be used. This pattern can be configured in RRC or indicated in MAC CE that activates the CSI report. In a second option, any of the approaches of FIGS. 13-15 can be considered, and a UE determination or a network indication can be implemented to support this option and indicate which approach to use.

Further, a value “T” or multiple values of “T” (e.g., “T1, “T2,” etc., or more generally “Ti”) can be configured in the RRC or indicated in the MAC CE that activates the report. When the value(s) is (are) in the activation signaling, different indication formats are possible. For multiple values, the value specific to “N” configuration can be indicated in association with the IDs of such configurations (e.g., {sub-config #i1, . . . sub-config #iN, Ti; sub-config #j1, . . . sub-config #jN, Tj}, where “il,” “iN,” “j1,” and “jN” are sub-configuration IDs, and “Ti” and “Tj” are two values). In another example, only one value of “T” is indicated and this value applies to all the sub-configurations. In yet another example, the values “T1,” “T2,” . . . , “Tp” are indicated, where “p=[T/N].” Here, the UE can associate each one of such values with the relevant “N” sub-configurations.

Also referring back to FIGS. 5-16, the CSI reporting can be aperiodic. For Aperiodic CSI reporting with “N<L,” a total of “N” CSI(s) can be reported. In this case, any of the approaches described in FIGS. 6-10 can be used. If the pattern approach of FIG. 6 is used, the network can indicate the pattern and the UE can report according to the pattern. The pattern can be indicated in an RRC configuration (e.g., the CSI report configuration), where the configuration orders the sub-configurations (e.g., optionally using their sub-configuration IDs). The pattern can additionally or alternatively be indicated in DCI that triggers the CSI report. If so, an “L” bit bitmap indicating which of the “N” CSI(s) are to be triggered can be indicated by the DCI. The remaining approaches can also be used, where the UE can be preprogrammed to support one approach or were the RRC/DCI signaling is used to indicate which one of the approaches is to be used.

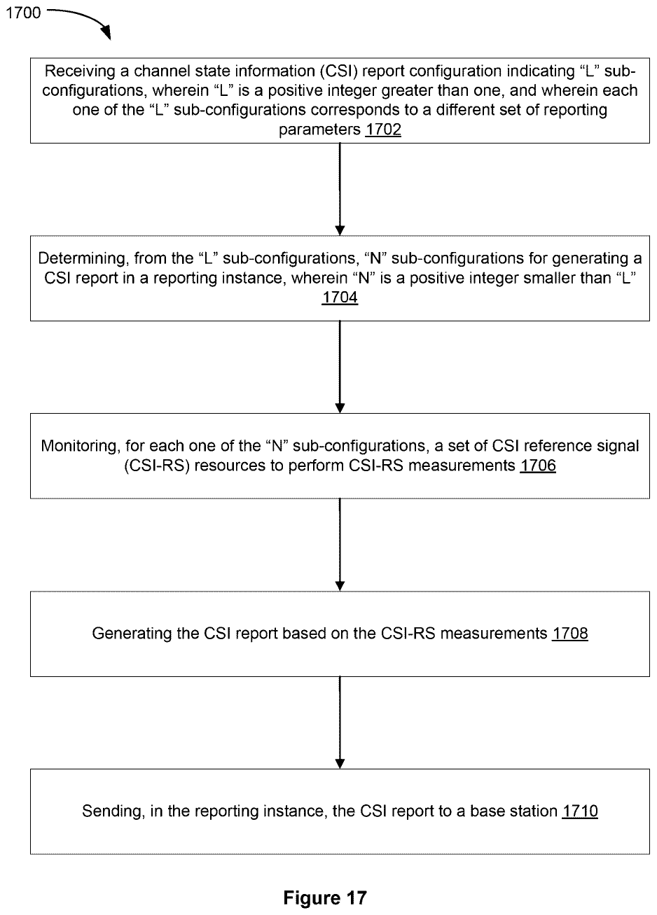

FIG. 17 illustrates an example of an operational flow/algorithmic structure 1700 for CSI reporting, in accordance with some embodiments. The operational flow/algorithmic structure 1700 can be performed by a UE as a whole and/or by particular components thereof. The UE is an example of any of the UEs described in the present disclosure.

In an example, the operational flow/algorithmic structure 1700 includes, at 1702, receiving a CSI report configuration indicating “L” sub-configurations, wherein “L” is a positive integer greater than one, and wherein each one of the “L” sub-configurations corresponds to a different set of reporting parameters. For instance, the CSI report configuration is signaled via RRC, indicates each sub-configuration and parameters related thereto, and includes an ordering or IDs of such sub-configurations.

In an example, the operational flow/algorithmic structure 1700 includes, at 1704, determining, from the “L” sub-configurations, “N” sub-configurations for generating a CSI report in a reporting instance, wherein “N” is a positive integer smaller than “L”. In one approach, the determination is based on a network indication, such as in FIG. 6 or 12. In another approach, the determination is based on execution of logic prestored by the UE, such as in any of FIG. 8-10 or 12-15. Further, the determination can be specific to a single reporting instance as in FIG. 5 or to multiple reporting instances where “N” sub-configurations are to be used for CSI reporting in each reporting instance as in FIG. 11. If multiple reporting instances are to be used to collectively report based on all “L” sub-configurations, the UE can also determine a value for “T,” such that CSI(s) determined based on “N” sub-configurations can be repeatedly reported in “T” consecutive reporting instances.

In an example, the operational flow/algorithmic structure 1700 includes, at 1706, monitoring, for each one of the “N” sub-configurations, a set of CSI reference signal (CSI-RS) resources to perform CSI-RS measurements. For instance, each of the “N” sub-configurations can indicate the set of CSI-RS resources to monitor (e.g., in the time and frequency domains). The UE uses these indications to detect the CSI-RSs and perform measurements thereon.

In an example, the operational flow/algorithmic structure 1700 includes, at 1708, generating the CSI report based on the CSI-RS measurements. For instance, depending on the type of CSI report and the specific parameters configured in the “N” sub-configurations, CQI, PMI, RI, etc. can be generated using the measurements.

In an example, the operational flow/algorithmic structure 1700 includes, at 1710, transmitting, in the reporting instance, the CSI report to a base station. For instance, the CSI report is sent in the reporting instance and the transmission can be repeated if a “T” value is configured.

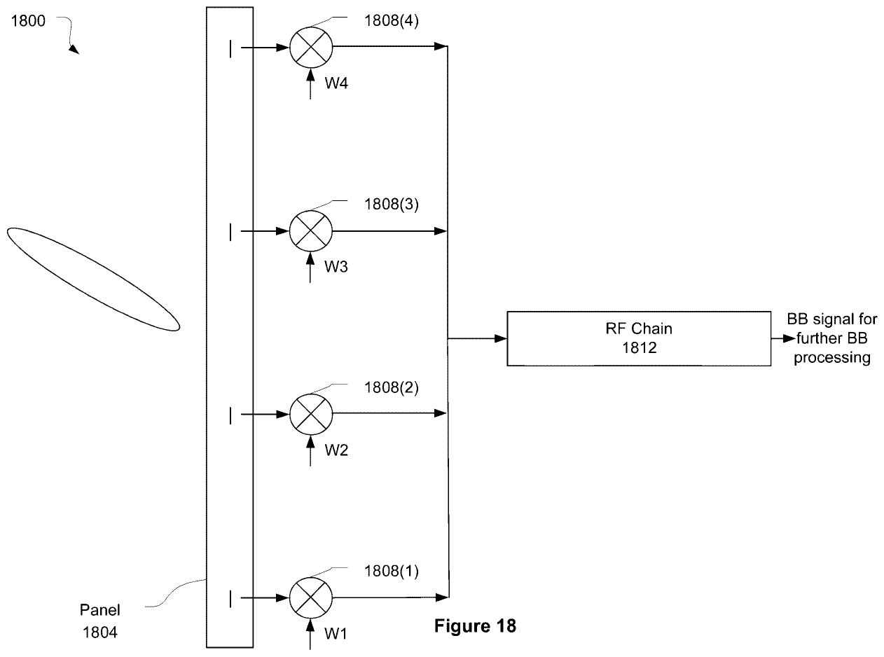

FIG. 18 illustrates receive components 1800 of the UE 104, or the gNB 108 in accordance with some embodiments. The receive components 1800 may include an antenna panel 1804 that includes a number of antenna elements. The panel 1804 is shown with four antenna elements, but other embodiments may include other numbers.

The antenna panel 1804 may be coupled to analog beamforming (BF) components that include a number of phase shifters 1808(1)-1808(4). The phase shifters 1808(1)-1808(4) may be coupled with a radio-frequency (RF) chain 1812. The RF chain 1812 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1808(1)-1808(4) to provide a receive beam at the antenna panel 1804. These BF weights may be determined based on the channel-based beamforming.

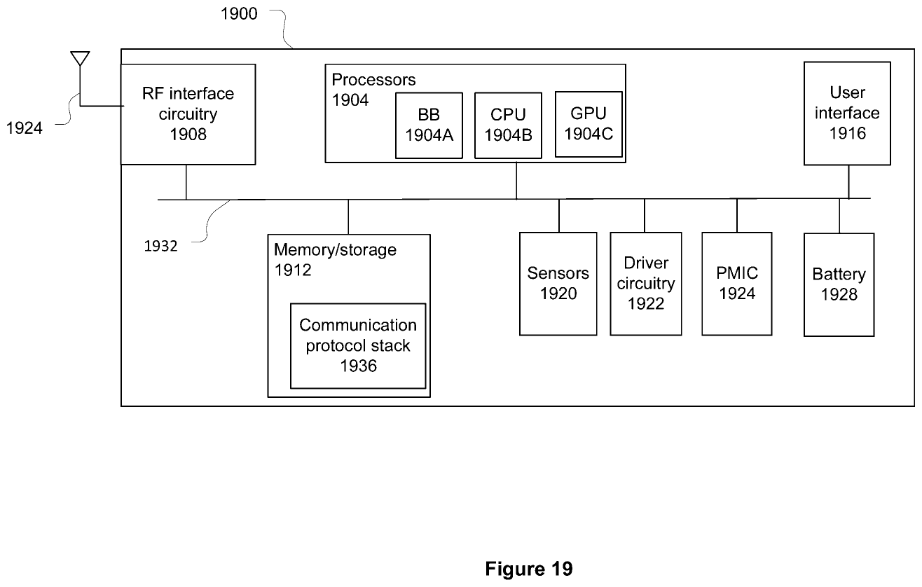

FIG. 19 illustrates a UE 1900 in accordance with some embodiments. The UE 1900 may be similar to and substantially interchangeable with UE 104 of FIG. 1.

Similar to that described above with respect to UE 104, the UE 1900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, and actuators), video surveillance/monitoring devices (for example, cameras, and video cameras), wearable devices, or relaxed-IoT devices. In some embodiments, the UE may be a reduced capacity UE or NR-Light UE.

The UE 1900 may include processors 1904, RF interface circuitry 1908, memory/storage 1912, user interface 1916, sensors 1920, driver circuitry 1922, power management integrated circuit (PMIC) 1924, and battery 1928. The components of the UE 1900 may be implemented as integrated circuits (ICs), portions thereof, discrete electronic devices, or other modules, logic, hardware, software, firmware, or a combination thereof. The block diagram of FIG. 19 is intended to show a high-level view of some of the components of the UE 1900. However, some of the components shown may be omitted, additional components may be present, and different arrangements of the components shown may occur in other implementations.

The components of the UE 1900 may be coupled with various other components over one or more interconnects 1932 which may represent any type of interface, input/output, bus (local, system, or expansion), transmission line, trace, optical connection, etc. that allows various circuit components (on common or different chips or chipsets) to interact with one another.

The processors 1904 may include processor circuitry such as, for example, baseband processor circuitry (BB) 1904A, central processor unit circuitry (CPU) 1904B, and graphics processor unit circuitry (GPU) 1904C. The processors 1904 may include any type of circuitry or processor circuitry that executes or otherwise operates computer-executable instructions, such as program code, software modules, or functional processes from memory/storage 1912 to cause the UE 1900 to perform operations as described herein.

In some embodiments, the baseband processor circuitry 1904A may access a communication protocol stack 1936 in the memory/storage 1912 to communicate over a 3GPP compatible network. In general, the baseband processor circuitry 1904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1908.

The baseband processor circuitry 1904A may generate or process baseband signals or waveforms that carry information in 3GPP-compatible networks. In some embodiments, the waveforms for NR may be based on cyclic prefix OFDM (CP-OFDM) in the uplink or downlink and discrete Fourier transform spread OFDM (DFT-S-OFDM) in the uplink.

The baseband processor circuitry 1904A may also access group information 1924 from memory/storage 1912 to determine search space groups in which a number of repetitions of a PDCCH may be transmitted.

The memory/storage 1912 may include any type of volatile or non-volatile memory that may be distributed throughout the UE 1900. In some embodiments, some of the memory/storage 1912 may be located on the processors 1904 themselves (for example, L1 and L2 cache), while other memory/storage 1912 is external to the processors 1904 but accessible thereto via a memory interface. The memory/storage 1912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1908 may include transceiver circuitry and a radio frequency front module (RFEM) that allows the UE 1900 to communicate with other devices over a radio access network. The RF interface circuitry 1908 may include various elements arranged in transmit or receive paths. These elements may include switches, mixers, amplifiers, filters, synthesizer circuitry, control circuitry, etc.

In the receive path, the RFEM may receive a radiated signal from an air interface via an antenna 1924 and proceed to filter and amplify (with a low-noise amplifier) the signal. The signal may be provided to a receiver of the transceiver that down-converts the RF signal into a baseband signal that is provided to the baseband processor of the processors 1904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1924.

In various embodiments, the RF interface circuitry 1908 may be configured to transmit/receive signals in a manner compatible with NR access technologies.

The antenna 1924 may include a number of antenna elements that each convert electrical signals into radio waves to travel through the air and to convert received radio waves into electrical signals. The antenna elements may be arranged into one or more antenna panels. The antenna 1924 may have antenna panels that are omnidirectional, directional, or a combination thereof to enable beamforming and multiple input, multiple output communications. The antenna 1924 may include micro-strip antennas, printed antennas that are fabricated on the surface of one or more printed circuit boards, patch antennas, phased array antennas, etc. The antenna 1924 may have one or more panels designed for specific frequency bands including bands in FR1 or FR2.

The user interface circuitry 1916 includes various input/output (I/O) devices designed to enable user interaction with the UE 1900. The user interface 1916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1900.

The sensors 1920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lens-less apertures); light detection and ranging sensors; proximity sensors (for example, infrared radiation detector and the like); depth sensors; ambient light sensors; ultrasonic transceivers; microphones or other like audio capture devices; etc.

The driver circuitry 1922 may include software and hardware elements that operate to control particular devices that are embedded in the UE 1900, attached to the UE 1900, or otherwise communicatively coupled with the UE 1900. The driver circuitry 1922 may include individual drivers allowing other components to interact with or control various input/output (I/O) devices that may be present within or connected to the UE 1900. For example, driver circuitry 1922 may include a display driver to control and allow access to a display device, a touchscreen driver to control and allow access to a touchscreen interface, sensor drivers to obtain sensor readings of sensor circuitry 1920 and control and allow access to sensor circuitry 1920, drivers to obtain actuator positions of electro-mechanic components or control and allow access to the electro-mechanic components, a camera driver to control and allow access to an embedded image capture device, or audio drivers to control and allow access to one or more audio devices.

The PMIC 1924 may manage power provided to various components of the UE 1900. In particular, with respect to the processors 1904, the PMIC 1924 may control power-source selection, voltage scaling, battery charging, or DC-to-DC conversion.

In some embodiments, the PMIC 1924 may control, or otherwise be part of, various power saving mechanisms of the UE 1900. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1900 may power down for brief intervals of time and thus save power. If there is no data traffic activity for an extended period of time, then the UE 1900 may transition off to an RRC_Idle state, where it disconnects from the network and does not perform operations such as channel quality feedback, handover, etc. The UE 1900 goes into a very low power state and it performs paging where again it periodically wakes up to listen to the network and then powers down again. The UE 1900 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay, and it is assumed the delay is acceptable.

A battery 1928 may power the UE 1900, although in some examples the UE 1900 may be mounted deployed in a fixed location and may have a power supply coupled to an electrical grid. The battery 1928 may be a lithium-ion battery, a metal-air battery, such as a zinc-air battery, an aluminum-air battery, a lithium-air battery, and the like. In some implementations, such as in vehicle-based applications, the battery 1928 may be a typical lead-acid automotive battery.

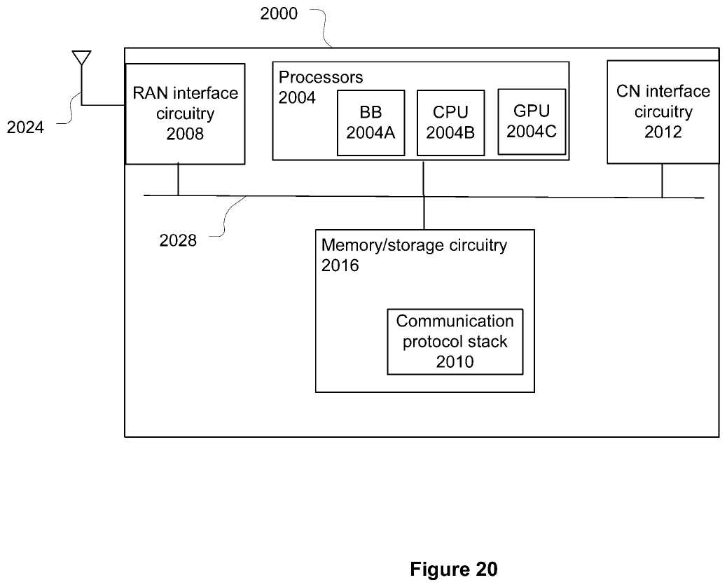

FIG. 20 illustrates a gNB 2000 in accordance with some embodiments. The gNB node 2000 may be similar to and substantially interchangeable with gNB 108. A base station can have the same or similar components as the gNB 2000.

The gNB 2000 may include processors 2004, RF interface circuitry 2008, core network (CN) interface circuitry 2012, and memory/storage circuitry 2016.

The components of the gNB 2000 may be coupled with various other components over one or more interconnects 2028.

The processors 2004, RF interface circuitry 2008, memory/storage circuitry 2016 (including communication protocol stack 2010), antenna 2024, and interconnects 2028 may be similar to like-named elements shown and described with respect to FIG. 18.

The CN interface circuitry 2012 may provide connectivity to a core network, for example, a 5^{th} Generation Core network (5GC) using a 5GC-compatible network interface protocol, such as carrier Ethernet protocols or some other suitable protocol. Network connectivity may be provided to/from the gNB 2000 via a fiber optic or wireless backhaul. The CN interface circuitry 2012 may include one or more dedicated processors or FPGAs to communicate using one or more of the aforementioned protocols. In some implementations, the CN interface circuitry 2012 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary embodiments are provided.

Example 1 includes a method implemented by a user equipment (UE), the method comprising: receiving a channel state information (CSI) report configuration indicating “L” sub-configurations, wherein “L” is a positive integer greater than one, and wherein each one of the “L” sub-configurations corresponds to a different a set of reporting parameters; determining, from the “L” sub-configurations, “N” sub-configurations for generating a CSI report in a reporting instance, wherein “N” is a positive integer smaller than “L”; monitoring, for each one of the “N” sub-configurations, a set of CSI reference signal (CSI-RS) resources to perform CSI-RS measurements; generating the CSI report based on the CSI-RS measurements; and sending, in the reporting instance, the CSI report to a base station.

Example 2 includes the method of example 1, wherein the CSI report configuration indicates the “N” sub-configurations of the “L” sub-configurations.

Example 3 includes the method of any preceding example, wherein the “N” sub-configurations are the first “N” sub-configurations of the “L” sub-configurations.

Example 4 includes the method of any preceding example, wherein each one of the “L” sub-configurations has an identifier, and wherein the “N” sub-configurations correspond to the smallest or largest “N” identifiers.

Example 5 includes the method of any preceding example, wherein each one of the “L” sub-configurations is associated with a CSI-RS configuration that indicates a set of parameters, wherein the “N” sub-configurations include “N” CSI-RS configurations having the “N” largest or smallest parameter values, and wherein the set of parameters includes at least one of a number of ports or a codebook size.

Example 6 includes the method of any preceding example, wherein each one of the “L” sub-configurations is associated with a CSI-RS configuration that indicates a set of parameters, wherein the “N” sub-configurations include “N1” CSI-RS configurations having the “N1” largest parameter values and “N2” CSI-RS configurations having the “N2” smallest parameter values, wherein “N” is equal to the sum of “N1” and “N2”.

Example 7 includes the method of any preceding example further comprising: determining that the “L” sub-configurations are to be reported in “L/N” reporting instances, wherein the “N” sub-configurations and the reporting instance are a first subset of the “L” sub-configurations and a first reporting instance of the “L/N” reporting instances, respectively; and determining a second subset of the “L” sub-configurations for a second reporting instance of the “L/N” reporting instances.

Example 8 includes the method of any preceding example further comprising: determining a pattern for selecting, for each reporting instance, a corresponding subset of the “L” sub-configurations, wherein the first subset and the second subset are each determined by being selecting from the “L” sub-configurations based on the pattern.

Example 9 includes the method of any preceding example, wherein the first subset includes the first “N” sub-configurations of the “L” sub-configurations, and wherein the second subset includes the next “N” sub-configurations of the “L” sub-configurations.

Example 10 includes the method of any preceding example, wherein each one of the “L” sub-configurations has an identifier, wherein the first subset corresponds to the smallest or largest “N” identifiers, and wherein the second subset corresponds to next smallest or largest “N” identifiers.

Example 11 includes the method of any preceding example, wherein each one of the “L” sub-configurations includes a CSI-RS configuration that indicates a set of parameters, wherein the first subset includes first “N” CSI-RS configurations having the “N” smallest or largest parameter values, and wherein the second subset includes second “N” CSI-RS configurations having the next “N” smallest or largest parameter values.

Example 12 includes the method of any preceding example, wherein each one of the “L” sub-configurations includes a CSI-RS configuration that indicates a set of parameters, wherein the first subset includes “N1” CSI-RS configurations having the “N1” largest parameter values and “N2” CSI-RS configurations having the “N2” smallest parameter values, wherein “N” is equal to the sum of “N1” and “N2”.

Example 13 includes the method of any preceding example further comprising: determining a number “T” for consecutive reporting, wherein the first subset is CSI-reported in “T” consecutive reporting instances before the second subset is CSI-reported in the next “T” consecutive reporting instances.

Example 14 includes the method of any preceding example further comprising: determining a first number “T1” for consecutive reporting associated with the first subset; and determining a second number “T2” for consecutive reporting associated with the second subset, wherein the first subset is CSI-reported in “T1” consecutive reporting instances before the second subset is CSI-reported in the next “T2” consecutive reporting instances.

Example 15 includes the method of any preceding example further comprising: determining a number “T” for consecutive reporting, wherein the number “T” is configured per sub-configuration of the “L” sub-configurations, and wherein the first subset is CSI-reported in “T” consecutive reporting instances.

Example 16 includes the method of any preceding example further comprising: determining that “L” sub-configurations are to be reported in “L/N” reporting instances, wherein “L′” is smaller or equal to “L” and is determined based on logic pre-stored by the UE or signaling received from the base station and activating semi-persistent CSI reporting, wherein the “N” sub-configurations and the reporting instance are a subset of the “L′” sub-configurations and a first reporting instance of the “L/N” reporting instances.

Example 17 includes the method of any preceding example further comprising: determining a pattern for selecting the “N” sub-configurations from the “L” sub-configurations to report in the reporting instance, wherein the pattern is indicated via radio resource control (RRC) signaling or downlink control information (DCI) that triggers aperiodic CSI reporting.

Example 18 includes the method of any preceding example further comprising: sending, to the base station, UE capability information indicating the UE's capability to support CSI reporting using a supported number of sub-configurations, wherein the CSI report configuration is received based on the supported number of sub-configurations.

Example 19 includes a user equipment (UE) comprising: one or more processors; and one or more memory storing instructions that, upon execution by the one or more processors, configure the UE to perform the method of any preceding example.

Example 20 includes one or more computer-readable media storing instructions that, when executed on a user equipment (UE), cause the UE to perform operations comprising those of the method of any preceding example.

Example 21 includes a device comprising means to perform one or more elements of a method described in or related to any of the preceding examples.

Example 22 includes one or more non-transitory computer-readable media comprising instructions to cause a device, upon execution of the instructions by one or more processors of the device, to perform one or more elements of a method described in or related to any of the preceding examples.

Example 23 includes a device comprising logic, modules, or circuitry to perform one or more elements of a method described in or related to any of the preceding examples.

Example 24 includes a device comprising: one or more processors and one or more computer-readable media comprising instructions that, when executed by the one or more processors, cause the one or more processors to perform one or more elements of a method described in or related to any of the preceding examples.

Example 25 includes a system comprising means to perform one or more elements of a method described in or related to any of the preceding examples.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations, and modifications will become apparent to those skilled in the art once the above disclosure is fully appreciated. It is intended that the following claims be interpreted to embrace all such variations and modifications.

1-20. (canceled)

21. An apparatus comprising:
processing circuitry configured to:
process a channel state information (CSI) report configuration indicating “L” sub-configurations, wherein “L” is a positive integer greater than one, and wherein each one of the “L” sub-configurations corresponds to a different a set of reporting parameters;
determine, from the “L” sub-configurations, “N” sub-configurations for generating a CSI report in a reporting instance, wherein “N” is a positive integer smaller than “L”;
monitor, for each one of the “N” sub-configurations, a set of CSI reference signal (CSI-RS) resources to perform CSI-RS measurements;
generate the CSI report based on the CSI-RS measurements; and
cause the CSI report to be sent, in the reporting instance, to a base station.

22. The apparatus of claim 21, wherein the CSI report configuration indicates the “N” sub-configurations of the “L” sub-configurations.

23. The apparatus of claim 21, wherein the “N” sub-configurations are the first “N” sub-configurations of the “L” sub-configurations.

24. The apparatus of claim 21, wherein each one of the “L” sub-configurations has an identifier, and wherein the “N” sub-configurations correspond to the smallest or largest “N” identifiers.

25. The apparatus of claim 21, wherein each one of the “L” sub-configurations is associated with a CSI-RS configuration that indicates a set of parameters, wherein the “N” sub-configurations include “N” CSI-RS configurations having the “N” largest or smallest parameter values, and wherein the set of parameters includes at least one of a number of ports or a codebook size.

26. The apparatus of claim 21, wherein each one of the “L” sub-configurations is associated with a CSI-RS configuration that indicates a set of parameters, wherein the “N” sub-configurations include “N1” CSI-RS configurations having the “N1” largest parameter values and “N2” CSI-RS configurations having the “N2” smallest parameter values, wherein “N” is equal to the sum of “N1” and “N2”.

27. A method the method comprising:
processing a channel state information (CSI) report configuration indicating “L” sub-configurations, wherein “L” is a positive integer greater than one, and wherein each one of the “L” sub-configurations corresponds to a different adaption of spatial elements of a base station;
determining, from the “L” sub-configurations, “N” sub-configurations for generating a CSI report in a reporting instance, wherein “N” is a positive integer smaller than “L”;
monitoring, for each one of the “N” sub-configurations, a set of CSI reference signal (CSI-RS) resources to perform CSI-RS measurements;
generating the CSI report based on the CSI-RS measurements; and
causing transmission, in the reporting instance, of the CSI report to the base station.

28. The method of claim 27 further comprising:
determining that the “L” sub-configurations are to be reported in “L/N” reporting instances, wherein the “N” sub-configurations and the reporting instance are a first subset of the “L” sub-configurations and a first reporting instance of the “L/N” reporting instances, respectively; and
determining a second subset of the “L” sub-configurations for a second reporting instance of the “L/N” reporting instances.

29. The method of claim 28 further comprising:
determining a pattern for selecting, for each reporting instance, a corresponding subset of the “L” sub-configurations, wherein the first subset and the second subset are each determined by being selecting from the “L” sub-configurations based on the pattern.

30. The method of claim 28, wherein the first subset includes the first “N” sub-configurations of the “L” sub-configurations, and wherein the second subset includes the next “N” sub-configurations of the “L” sub-configurations.

31. The method of claim 28, wherein each one of the “L” sub-configurations has an identifier, wherein the first subset corresponds to the smallest or largest “N” identifiers, and wherein the second subset corresponds to next smallest or largest “N” identifiers.

32. The method of claim 28, wherein each one of the “L” sub-configurations includes a CSI-RS configuration that indicates a set of parameters, wherein the first subset includes first “N” CSI-RS configurations having the “N” smallest or largest parameter values, and wherein the second subset includes second “N” CSI-RS configurations having the next “N” smallest or largest parameter values.

33. The method of claim 28, wherein each one of the “L” sub-configurations includes a CSI-RS configuration that indicates a set of parameters, wherein the first subset includes “N1” CSI-RS configurations having the “N1” largest parameter values and “N2” CSI-RS configurations having the “N2” smallest parameter values, wherein “N” is equal to the sum of “N1” and “N2”.

34. The method of claim 28 further comprising:
determining a number “T” for consecutive reporting, wherein the first subset is CSI-reported in “T” consecutive reporting instances before the second subset is CSI-reported in the next “T” consecutive reporting instances.

35. The method of claim 28 further comprising:
determining a first number “T1” for consecutive reporting associated with the first subset; and
determining a second number “T2” for consecutive reporting associated with the second subset, wherein the first subset is CSI-reported in “T1” consecutive reporting instances before the second subset is CSI-reported in the next “T2” consecutive reporting instances.

36. The method of claim 28 further comprising:
determining a number “T” for consecutive reporting, wherein the number “T” is configured per sub-configuration of the “L” sub-configurations, and wherein the first subset is CSI-reported in “T” consecutive reporting instances.

37. One or more computer-readable media storing instructions that, when executed, cause operations comprising:
processing a channel state information (CSI) report configuration indicating “L” sub-configurations, wherein “L” is a positive integer greater than one, and wherein each one of the “L” sub-configurations corresponds to a different adaption of spatial elements of a base station;
determining, from the “L” sub-configurations, “N” sub-configurations for generating a CSI report in a reporting instance, wherein “N” is a positive integer smaller than “L”;
monitoring, for each one of the “N” sub-configurations, a set of CSI reference signal (CSI-RS) resources to perform CSI-RS measurements;
generating the CSI report based on the CSI-RS measurements; and
causing transmission, in the reporting instance, of the CSI report to the base station.

38. The one or more computer-readable media storing of claim 37, wherein the operations further comprise:
determining that “L”“ sub-configurations are to be reported in ”L/N“ reporting instances, wherein ”L“ is smaller or equal to ”L“ and is determined based on logic pre-stored by a user equipment (UE) or signaling received from the base station and activating semi-persistent CSI reporting, wherein the ”N“ sub-configurations and the reporting instance are a subset of the ”L“” sub-configurations and a first reporting instance of the “L/N” reporting instances.

39. The one or more computer-readable media storing of claim 37, wherein the operations further comprise:
determining a pattern for selecting the “N” sub-configurations from the “L” sub-configurations to report in the reporting instance, wherein the pattern is indicated via radio resource control (RRC) signaling or downlink control information (DCI) that triggers aperiodic CSI reporting.

40. The one or more computer-readable media storing of claim 37, wherein the operations further comprise:
generating, for transmission to the base station, user equipment (UE) capability information indicating a UE's capability to support CSI reporting using a supported number of sub-configurations, wherein the CSI report configuration is received based on the supported number of sub-configurations.
